(19) United States
(12) Patent Application Publication
(10) Pub. No.: US 2022/0063440 A1
(43) Pub. Date: Mar. 3, 2022

(54) CHARGING SYSTEMS AND METHODS FOR ELECTRIC VEHICLES

(71) Applicant: GM GLOBAL TECHNOLOGY OPERATIONS LLC, Detroit, MI (US)

(72) Inventors: Claudia V. Goldman-Shenhar, Mevasseret Zion (IL); Nadav Baron, Herzliya (IL); Barak Hershkovitz, Herzliya (IL); Dima Zevelev, Herzliya (IL); Omar Gonzalez, Wixom, MI (US); Shani Avnet, Herzliya (IL)

(73) Assignee: GM GLOBAL TECHNOLOGY OPERATIONS LLC, Detroit, MI (US)

(21) Appl. No.: 17/102,968

(22) Filed: Nov. 24, 2020

Related U.S. Application Data
(60) Provisional application No. 63/071,135, filed on Aug. 27, 2020.

(51) Int. Cl. B60L 53/66

(52) U.S. Cl. CPC B60L 53/665; B60L 2240/72; B60L 2240/62; B60L 2240/66; B60L 2240/68; B60L 2240/645

(57) ABSTRACT

Systems and method are provided for controlling a vehicle having one or more batteries. In one embodiment, a method includes: receiving, by a processor, data from at least two of a user of the vehicle, the vehicle, one or more charging stations, and one or more vehicle services; determining, by the processor, optimization criteria based on the received data; computing, by the processor, a charging route solution based on the optimization criteria; and generating, by the processor, interface data for presenting the charging route solution to the user of the vehicle.

### INTRODUCTION

The present disclosure generally relates to electric vehicles, and more particularly relates to systems and methods for determining best charging and routing options for a user.

An autonomous vehicle is a vehicle that is capable of sensing its environment and navigating with little or no user input. An autonomous vehicle senses its environment using sensing devices such as radar, lidar, image sensors, and the like. The autonomous vehicle system further uses information from global positioning systems (GPS) technology, navigation systems, vehicle-to-vehicle communication, vehicle-to-infrastructure technology, and/or drive-by-wire systems to navigate the vehicle.

While autonomous vehicles and semi-autonomous vehicles offer many potential advantages over traditional vehicles, in certain circumstances it may be desirable for improved operation of the vehicles. For example, some autonomous vehicles and semi-autonomous vehicles are electric or hybrid electric vehicles that include at least one battery. After extended use of the electric or hybrid electric vehicle, the state of charge of the battery may become low and needs to be recharged. Accordingly, it is desirable to provide systems and methods that identify a route that optimizes charging of the battery during operation of the vehicle. Furthermore, other desirable features and characteristics of the present invention will become apparent from the subsequent detailed description and the appended claims, taken in conjunction with the accompanying drawings and the foregoing technical field and background.

### SUMMARY

Systems and method are provided for controlling a vehicle having one or more batteries. In one embodiment, a method includes: receiving, by a processor, data from at least two of a user of the vehicle, the vehicle, one or more charging stations, and one or more vehicle services; determining, by the processor, optimization criteria based on the received data; computing, by the processor, a charging route solution based on the optimization criteria; and generating, by the processor, interface data for presenting the charging route solution to the user of the vehicle.

In various embodiments, the optimization criteria includes a user preference. In various embodiments the user preference indicates at least one of cost to charge, a time to charge, and a health of batteries.

In various embodiments, the optimization criteria includes weights associated with at least one of cost to charge, a time to charge, and a health of batteries.

In various embodiments, the optimization criteria includes services provided for each routing option.

In various embodiments, the optimization criteria includes weights associated with at least one of confidence and predictability of routing options.

In various embodiments, the method further includes storing user selections associated with the charging route solution; and training a preference model based on the user selections. In various embodiments, the optimization criteria is based on the trained preference model.

In various embodiments, the method further includes generating an interface configured to solicit the data from the user of the vehicle, wherein the data includes at least one of user preferences, weights, and user needs.

In various embodiments, the data received from the one or more charging station includes data associated with a location, a time to charge, a waiting time to charge, and a cost to charge.

In various embodiments, the data received from the vehicle includes data associated with a current charge of the one or more batteries, and a current temperature of the one or more batteries.

In various embodiments, the data received from the one or more vehicle services includes data associated with weather, traffic, topography, and road type.

In various embodiments, the charging route solution includes services available at a chosen charging station, charging duration, charging station location, and the price of the charging.

In another embodiment, a computer implemented system for controlling a vehicle having one or more batteries is provided. The computer implemented system includes a charging system module that comprises one or more processors configured by programming instructions encoded in non-transitory computer readable media. The charging system module is configured to: receive data from at least two of a user of the vehicle, the vehicle, one or more charging stations, and one or more vehicle services, and determine, optimization criteria based on the received data; compute a charging route solution based on the optimization criteria; and generate interface data for presenting the charging route solution to the user of the vehicle.

In various embodiments, the optimization criteria includes a user preference.

In various embodiments, the user preference indicates at least one of cost to charge, a time to charge, and a health of batteries.

In various embodiments, the optimization criteria includes weights associated with at least one of cost to charge, a time to charge, and a health of batteries.

In various embodiments, the optimization criteria includes services provided for each routing option.

In various embodiments, the optimization criteria includes weights associated with at least one of confidence and predictability of routing options.

In various embodiments, the charging system module is further configured to store user selections associated with the charging route solution, and train a preference model based on the user selections.

### BRIEF DESCRIPTION OF THE DRAWINGS

The exemplary embodiments will hereinafter be described in conjunction with the following drawing figures, wherein like numerals denote like elements, and wherein:

FIG. 1 is a functional block diagram illustrating a vehicle having a charging system, in accordance with various embodiments;

FIG. 2 is a dataflow diagram illustrating a charging system, in accordance with various embodiments; and

FIG. 3 is a flowchart illustrating a charging method that may be performed by the vehicle and the charging system, in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

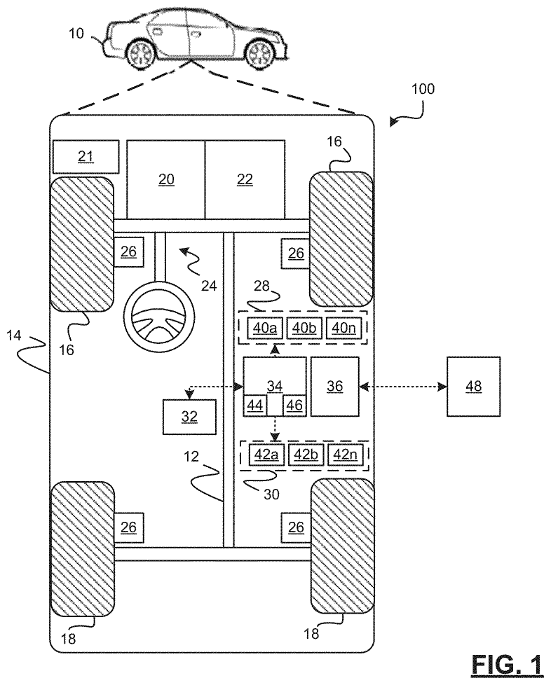

With reference to FIG. 1, a charging system shown generally at 100 is associated with a vehicle 10 in accordance with various embodiments. In general, the charging system 100 receives and processes data in order to compute a route for the vehicle 10, including navigation and charging stops, that optimizes for time of charging, health state of the battery, and user's needs and preferences considering route constraints, services on the road, distance of charging stations from route and services along the route.

As can be appreciated, embodiments of the present disclosure are applicable to electric and hybrid electric vehicles of non-autonomous vehicles, semi-autonomous vehicles, and autonomous vehicles. For exemplary purposes, the disclosure will be discussed in the context of a charging system 100 for an autonomous vehicle.

As depicted in the example of FIG. 1, the vehicle 10 is an automobile and generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16-18 are each rotationally coupled to the chassis 12 near a respective corner of the body 14.

In various embodiments, the vehicle 10 is an autonomous vehicle and the charging system 100 described herein is incorporated into the autonomous vehicle (hereinafter referred to as the autonomous vehicle 10). The autonomous vehicle 10 is, for example, a vehicle that is automatically controlled to carry passengers from one location to another. The vehicle 10 is depicted in the illustrated embodiment as a passenger car, but it should be appreciated that any other vehicle including motorcycles, trucks, sport utility vehicles (SUVs), recreational vehicles (RVs), marine vessels, aircraft, etc., can also be used.

As shown, the vehicle 10 generally includes a propulsion system 20, a transmission system 22, a steering system 24, a brake system 26, a sensor system 28, an actuator system 30, at least one data storage device 32, at least one controller 34, and a communication system 36. The propulsion system 20, in various embodiments, includes an electric machine, such as a traction motor powered by one or more batteries, alone (e.g., as a pure electric vehicle) or in combination with an internal combustion engine and/or a fuel cell propulsion system (e.g., as a hybrid electric vehicle). The batteries of the propulsion system 20 are associated with a battery management system 21 having a port that provides charging access to the batteries through, for example, the body 14 of the vehicle 10. In various embodiments, the port may be accessed by way of a door or cover coupled to the body 14 of the vehicle 10.

The transmission system 22 is configured to transmit power from the propulsion system 20 to the vehicle wheels 16-18 according to selectable speed ratios. According to various embodiments, the transmission system 22 may include a step-ratio automatic transmission, a continuously-variable transmission, or other appropriate transmission. The brake system 26 is configured to provide braking torque to the vehicle wheels 16-18. The brake system 26 may, in various embodiments, include friction brakes, brake by wire, a regenerative braking system such as an electric machine, and/or other appropriate braking systems. The steering system 24 influences a position of the of the vehicle wheels 16-18. While depicted as including a steering wheel for illustrative purposes, in some embodiments contemplated within the scope of the present disclosure, the steering system 24 may not include a steering wheel.

The sensor system 28 includes one or more sensing devices 40a-40n that sense observable conditions of the exterior environment and/or the interior environment of the autonomous vehicle 10. The sensing devices 40a-40n can include, but are not limited to, radars, lidars, global positioning systems, optical cameras, thermal cameras, ultrasonic sensors, inertial measurement units, and/or other sensors. In various embodiments, the sensor system 28 further includes one or more sensing devices 41a-41n that sense observable conditions of one or more vehicle components. For example, at least one sensing device 41a senses chemical properties, voltage, current, and/or other properties of the batteries of the propulsion system 20. The sensor measurements are then used to estimate a state of charge of the batteries.

The actuator system 30 includes one or more actuator devices 42a-42n that control one or more vehicle features such as, but not limited to, the propulsion system 20, the transmission system 22, the steering system 24, and the brake system 26. In various embodiments, the vehicle features can further include interior and/or exterior vehicle features such as, but are not limited to, doors, a trunk, and cabin features such as air, music, lighting, etc. (not numbered).

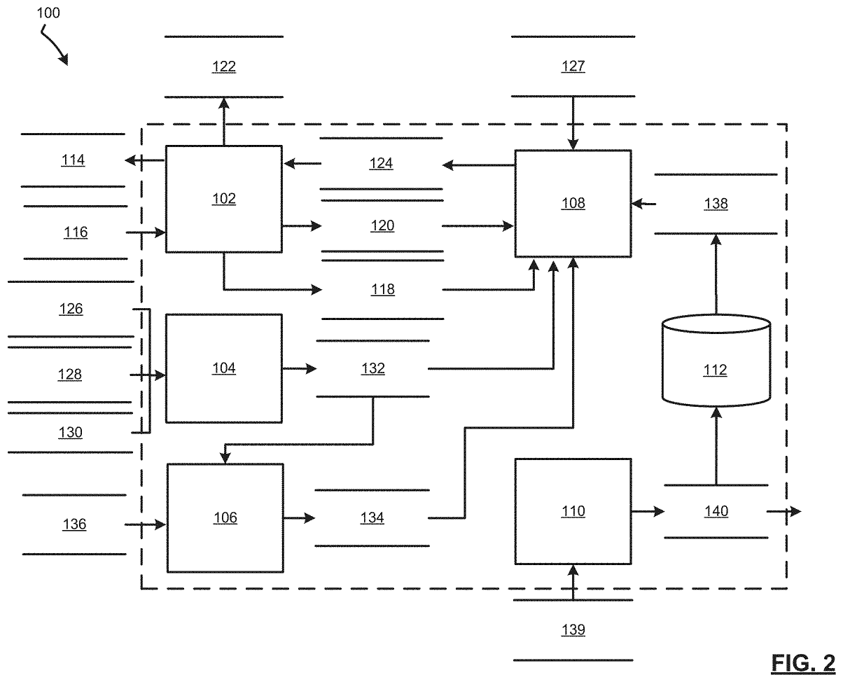

The communication system 36 is configured to wirelessly communicate information to and from other entities 48, such as but not limited to, other vehicles (“V2V” communication,) infrastructure (“V2I” communication), remote systems, charging stations, and/or personal devices (described in more detail with regard to FIG. 2). In an exemplary embodiment, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

The data storage device 32 stores data for use in automatically controlling the autonomous vehicle 10. In various embodiments, the data storage device 32 stores defined maps of the navigable environment. In various embodiments, the defined maps may be predefined by and obtained from a remote system (described in further detail with regard to FIG. 2). For example, the defined maps may be assembled by the remote system and communicated to the autonomous vehicle 10 (wirelessly and/or in a wired manner) and stored in the data storage device 32. Route information may also be stored within data storage device 32—i.e., a set of road segments (associated geographically with one or more of the defined maps) that together define a route that the user may take to travel from a start location (e.g., the user's current location) to a target location. As can be appreciated, the data storage device 32 may be part of the controller 34, separate from the controller 34, or part of the controller 34 and part of a separate system.

The controller 34 includes at least one processor 44 and a computer readable storage device or media 46. The processor 44 can be any custom made or commercially available processor, a central processing unit (CPU), a graphics processing unit (GPU), an auxiliary processor among several processors associated with the controller 34, a semiconductor based microprocessor (in the form of a microchip or chip set), a macroprocessor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the autonomous vehicle 10. In various embodiments, the controller 34 is configured to implement charging systems and methods as discussed in detail below.

The instructions of the controller 34 may include one or more separate programs, each of which comprises an ordered listing of executable instructions for implementing logical functions. The instructions, when executed by the processor 44, receive and process signals from the sensor system 28, perform logic, calculations, methods and/or algorithms for automatically controlling the components of the autonomous vehicle 10, and generate control signals to the actuator system 30 to automatically control the components of the autonomous vehicle 10 based on the logic, calculations, methods, and/or algorithms. Although only one controller 34 is shown in FIG. 1, embodiments of the autonomous vehicle 10 can include any number of controllers 34 that communicate over any suitable communication medium or a combination of communication mediums and that cooperate to process the sensor signals, perform logic, calculations, methods, and/or algorithms, and generate control signals to automatically control features of the autonomous vehicle 10.

As mentioned briefly above, all or part of the charging system 100 of FIG. 1 is included within the controller 34. As shown in more detail with regard to FIG. 2 and with continued reference to FIG. 1, the charging system 100 may be implemented as one or more modules configured to perform one or more methods. As can be appreciated, the module shown in FIG. 2 can be combined and/or further partitioned in order perform the functions or methods described herein. Furthermore, inputs to the charging system 100 may be received from the sensor system 28, received from other control modules (not shown) associated with the vehicle 10, received from the communication system 36, and/or determined/modeled by other sub-modules (not shown) within the controller 34 of FIG. 1. Furthermore, the inputs might also be subjected to preprocessing, such as sub-sampling, noise-reduction, normalization, feature-extraction, missing data reduction, and the like.

In various embodiments, the modules include a user interface manager module 102, a battery data prediction module 104, a charging station data prediction module 106, a route solution determination module 108, a user model training module 110, and a model datastore 112.

The user interface manager module 102 manages the display of and user interaction with an interface configured to display charging information and receive user information. In various embodiments, the user interface manager module 102 generates user interface data 114 to display the interface to a user of the vehicle 10 (e.g., through a display device of the vehicle 10 and/or a personal device). In various embodiments, the interface solicits user information from a user of the vehicle 10. For example, the interface includes one or more text boxes, selection boxes, selection buttons, slider bars, menus, and/or any other input items that allow a user to enter user data. As can be appreciated, the user data can be entered in the input items using various input means including speech, hand selection, etc.

In various embodiments, the user data can include, but are not limited to, charging needs, charging preferences, and/or tradeoffs between time, cost, number of stops, detours, services, etc. associated with charging. For example, in various embodiments, the interface may be configured to accept user input indicating any of the following:

1) What are my best options for charging on my route, if I have only a half hour to spend on charging beyond the one-hour usual trip I have to work.

2) I want to choose a route from those that the system is confident about with high confidence about their time and costs.

3) I would like to charge at a charging station while I shop for usual groceries

4) My time is more important than the cost I will be charged but I still do care about costs.

5) I care about the life span of my battery but not that much to pay more than ten dollars per charge.

As can be appreciated, the above-mentioned examples are just a few of any number of inputs that can be provided by a user and are provided for exemplary purposes to illustrate the various configurations of interface.

In various embodiments, the user interface manager module 102 receives user input data 116 generated as a result of the user interacting with the interface. The user interface manager module 102 then analyzes the user input data 116 to determine user preference data 118 and weight data 120. In various embodiments, the weight data 120 includes percentages associated with a preference that indicate the expressed tradeoff entered by the user.

In various embodiments, the user interface manager module 102 generates route solution interface data 122 including route solution data 124 provided by the route solution determination module 108. The route solution interface data 122 is displayed to the user (e.g., via a display of the vehicle 10 and/or a personal device). In various embodiments, a user can request many times to see routes and charging options before or during a route, changing their preferences to obtain updated solutions given the current location and destination, and battery temperature and levels of charge. In such embodiments, the user interface manager module 102 provides updated route solution interface data 122 based on updated route solution data 124. In various embodiments, the user interface manager module 102 provides the route solution interface data 122 based on a scheduled time or event that is unsolicited by the user. For example, the route solution interface data 122 may be based on route solution data 124 that is based on a preference model that is learned over time based on predicted route solutions and the user's (and/or other user's) selection of and/or following of predicted route solutions.

In various embodiments, the battery data prediction module 104 receives as input current battery data 126 (e.g., including battery temperature and battery level of charge), driving features data 128, and routing data 130 (e.g., current location and destination location). In various embodiments, the driving features can include, but are not limited to, a driving profile, a topography (e.g., mountain, hills, flat road, etc.) along a route, a road type (e.g., highway, urban) along the route, accessories used (e.g., HVAC system), a state of the battery, the weather (temperature in general), a geo location, and traffic conditions (e.g., level of congestion).

Based on the inputs, the 126-130, the battery data prediction module 104 determines battery prediction data 132 associated with the batteries of the vehicle 10. In various embodiments, the battery prediction data 132 includes a predicted battery temperature at the destination, a predicted level of charge to reach the destination, and a predicted charge time to reach the level of charge. For example, the predicted battery temperature can be determined based the current temperature of the batteries, a time it will take to reach the next stop, the driving features, and a battery model that takes into account the driving features. Thereafter, the level of charge to reach the destination can be determined from the current route and the driving profile of the user; and the duration of charging to reach the level of charge can be determined from the determined level of charge, a defined battery model, and the current battery temperature.

The charging station data prediction module 106 receives as input the battery prediction data 132, and charging station data 136 (e.g., provided by the various charging stations and/or a remote transportation system). In various embodiments, the charging station data 136 includes data such as charging station location, charging station capacity, charging station capability, charging station traffic, charging costs, etc.

The charging station data prediction module 106 determines charging station prediction data 134 for each charging station located within a defined radius from the current location. In various embodiments, the radius is predefined or selected by a user (e.g. via the interface). In various embodiments, the charging station prediction data 134 includes a time to charge the needed level of charge, a waiting time to charge, and a price to charge.

In various embodiments, the route solution determination module 108 receives as input location data 127 (e.g., including a desired destination and a current location), the weight data 120, the user preference data 118, the battery prediction data 132, the charging station prediction data 134, and modeled preference data 138. Given the input data, the route solution determination module 108 determines one or more best solutions for a route to be taken by the vehicle 10 and provides the route solution data 124 based thereon. In various embodiments, the route solution determination module 108 determines the one or more best solutions by computing an optimal charging solution given optimization criteria. In various embodiments, the optimization criteria can include optimization for cost, optimization for time, optimization for battery life, optimization for waiting time, optimization for user's preferred tradeoffs, optimization for power availability, optimization for services provided, and optimization for confidence or predictability in result. The optimization criteria used can be used as standard or baseline optimizations and/or selected based on the user preference data 118, the weight data 120, and/or the modeled preference data 138.

For example, in various embodiments, the user preference data 118 can indicate that the best solution provides a fastest route, a cheapest route, or a healthiest route for the batteries. When the user preference data 118 indicates that a fastest route is desired, the route solution determination module 108 determines the best routes by optimizing for time.

In various embodiments, the route solution determination module 108 optimizes for time by: computing the fastest route between points A and B; setting the current level of charge of battery at origin A; setting the current temperature to the current battery temperature of battery at origin A; setting the desired level of charge of battery at destination B; and listing all charging stations between A and B (LC).

Thereafter, given current traffic, topography, route type (highway, urban, rural), and current state of battery (temperature, type), a modified list (LC+) including a list of triplets where each triplet includes a charging station, the predicted battery temperature when the vehicle arrives at the station, and the predicted level of charge at arrival at the charging station. Thereafter, for each element in the modified list (LC+), given the desired level of charge at destination B, the duration of charging, price, waiting time from the predicted temperature of battery and predicted level of charge at charging station are computed.

Thereafter, the list (LC+) is sorted by shortest time. The chosen charging station is set to the first element in the sorted list. If there are more than one station with equal minimal time, the charging station with the cheapest prices is chosen. If there are also several stations with equal time and equal price, then the charging station that is healthiest for the battery is chosen. Services available at the selected charging station are listed and the values of charging station duration along the route, the chosen charging station location, and the price of the charging are output as the route solution data 124.

In various embodiments, when the user preference data 118 indicates that the cheapest route is desired, the route solution determination module 108 determines the best route by optimizing for cost. In various embodiments, the route solution determination module 108 optimizes for cost by: setting current level of charge of battery at origin A; setting the current battery temperature of battery at origin A; setting the desired level of charge of battery at destination B; and listing at most X routes between A and B (LR).

Thereafter, for each element in the list (LR) list all charging stations between A and B (LC). Given traffic, topography, route type (e.g., highway, urban, rural), and current state of battery (e.g., temperature, type) a modified list(LC+) including a list of triplets where each triplet includes a charging station, the predicted battery temperature when the vehicle arrives at the station, and the predicted level of charge at arrival at the charging station. For each element in the modified (LC+) and given the desired level of charge at destination B, the duration of charging, price, waiting time from the predicted temperature of battery and predicted level of charge at charging station are computed.

Thereafter, the list (LC+) is sorted by cheapest charging cost. The chosen charging station is set to the first element in the stored list. If several stations have the same minimum price, the charging station with the healthiest battery solution or the charging station with the best time is selected (e.g., based on the user's preferences). Services available at the chosen charging station are listed and the values of charging station duration along the route, the chosen charging station location, and the price of the charging are output as the route solution data 124.

In various embodiments, when the user preference data 118 indicates that the healthiest route is desired, the route solution determination module 108 determines the best solutions by optimizing for battery life. In various embodiments, the route solution determination module 108 optimizes for battery life by: setting the current level of charge of battery at origin A; setting the current battery temperature of battery at origin A; setting the desired level of charge of battery at destination B; listing at most X routes between A and B and choosing the one that is healthiest for the batteries; and listing all charging stations between A and B on the chosen route (LC).

Thereafter, given traffic, topography, route type (highway, urban, rural), and current state of battery (e.g., temperature, type) a modified list (LC+) is computed including a list of triplets where each triplet includes a charging station, the predicted battery temperature when the vehicle arrives at the station, and the predicted level of charge at arrival at the charging station. Thereafter, for each element in the modified list (LC+) and given the desired level of charge at destination B, the duration of charging, price, waiting time from predicted temperature of battery and predicted level of charge at charging station are computed.

Thereafter, the list (LC+) is sorted by the battery health score. The chosen charging station is set to the first element in the sorted list. If several stations have the same shortest time and/or score, the charging station with the cheapest price is chosen. Services available at the chosen charging station are listed and the values of charging station duration along the route, the chosen charging station location, and the price of the charging are output as the route solution data 124.

In various embodiments, when the weight data 120 indicates interpreted tradeoffs or weights between preferences, the route solution determination module 108 determines the best route by optimizing using weights. In various embodiments, the route solution determination module 108 optimizes for weights by computing all routes R1 . . . Rn (between A to B) and for all charging stations C1 . . . Ck on Ri as:

F(Ri,Cj)=Weight(Time)*(Time(Ri)+ChargingTime(Cj))+Weight(Cost)*Cost(Cj)−Weight(Health)*Score(Ri,Cj),

when the predicted level of charge of battery desired at destination B based on vehicle constraints and user preferences is greater than or equal to a minimum charge, and where ChargingTime_Cj represents the predicted time, Score_RC represents the predicted score, Cost_C represents the determined cost, TimeR represents the calculated time that takes to ride route Ri at the speed expected. Services available at the chosen charging station are listed and the values of charging station duration along the route, the chosen charging station location, and the price of the charging are output as the route solution data 124.

In various embodiments, when the weight data 120 indicates interpreted tradeoffs or weights between preferences including services, the route solution determination module 108 determines the best route by optimizing using the weights and services listed at each charging station. In various embodiments, the route solution determination module 108 optimizes for weights and services by computing all routes R1 . . . Rn (between A to B) and for all charging stations C1 . . . Ck on Ri as:

F(Ri,Cj)=Weight_s*[Weight_time(Time)*(TimeR+ChargingTime_Cj)+Weight_cost(Cost)*Cost_C−Weight_health(Health)*Score_RC],

when the predicted level of charge of battery desired at destination B based on vehicle constraints and user preferences is greater than or equal to a minimum charge, and when Ci provides a service s in List s, Weight_s represents Score_s(s), otherwise Weight_s is set to zero, where ChargingTime_Cj represents the predicted time, Score_RC represents the predicted score, Cost C represents the determined cost, TimeR represents the calculated time that takes to ride route Ri at the speed expected.

Services available at the chosen charging station are listed and the values of charging station duration along the route, the chosen charging station location, and the price of the charging are output as the route solution data 124.

As can be appreciated, the methods described herein are exemplary, as other methods can be performed by the route solution determination module 108 in various embodiments to determine the route solution data 124, depending on the weights, preferences, and tradeoffs entered by the user.

In various embodiments, the user model training module 110 receives as input user selection data 139 indicating the routes and charging stations that were selected or followed by the user as a result of the route solutions provided. The user model training module 110 stores the user preferences and selected routes and charging stations and uses the stored data to train a personalized model of charging and preferences for users. The user model training module 110 stores the training data 140 in the model datastore 112 for use by the route solution determination module 108. In various embodiments, the training data 140 can be further provided to charging stations for data analytics and better settings of future prices and management of charging stations based on data logged at charging stations, and a computed dynamic model of pricing for charging.

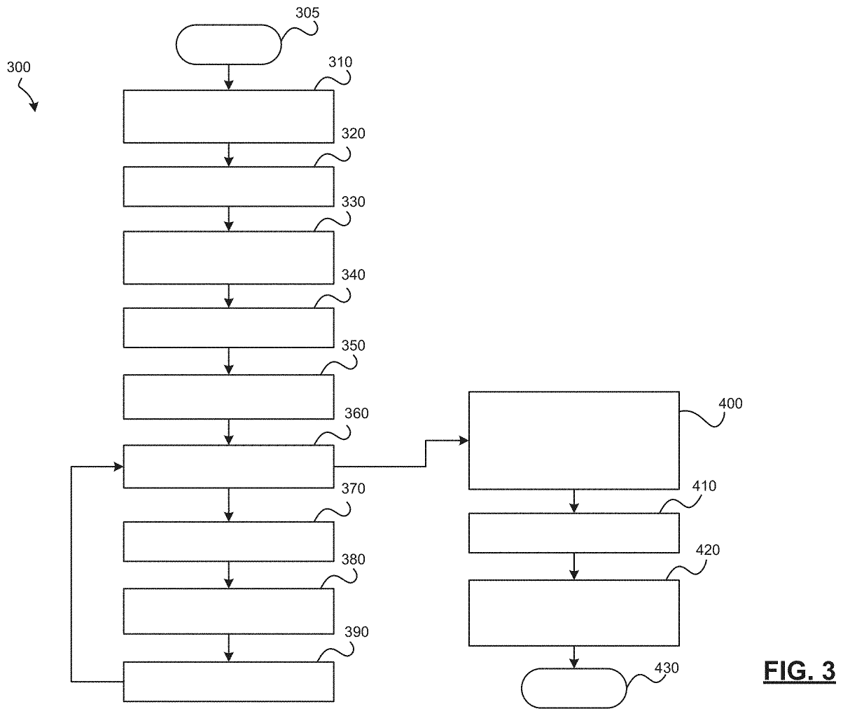

Referring now to FIG. 3, and with continued reference to FIGS. 1-2, a flowchart illustrates a control method 300 that can be performed by the charging system 100 of FIGS. 1 and 2 in accordance with the present disclosure. As can be appreciated in light of the disclosure, the order of operation within the method is not limited to the sequential execution as illustrated in FIG. 3 but may be performed in one or more varying orders as applicable and in accordance with the present disclosure. In various embodiments, the method 300 can be scheduled to run based on one or more predetermined events, and/or can run continuously during operation of the vehicle 10.

In various embodiments, the method 300 may begin at 305. Thereafter, at 310, user input data is received at 310, for example, based on a generated interface as discussed above. The user input data is interpreted for preference data and/or weight data at 320. The battery temperature is predicted at a destination at 330. The level of charge to reach the destination is predicted at 340. The time to charge to the predicted level is predicted at 350.

Thereafter, at 360, for each charging station in a defined radius of the vehicle 10, the time to charge to reach the predicted level is determined at 370, the predicted time to wait is determined at 380, and the predicted cost is determined at 390.

Once the information is predicted for each charging station at 360, the route solution is determined at 400 based on the weights data, the preference data, the predicted battery data, and the predicted charging station data, for example, as discussed above. Any user responses are logged at 410 and a preference model is trained based on the logged data at 420. Thereafter, the method may end at 430.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method of controlling a vehicle having one or more batteries, comprising:
receiving, by a processor, data from at least two of a user of the vehicle, the vehicle, one or more charging stations, and one or more vehicle services;
determining, by the processor, optimization criteria based on the received data;
computing, by the processor, a charging route solution based on the optimization criteria; and
generating, by the processor, interface data for presenting the charging route solution to the user of the vehicle.

2. The method of claim 1, wherein the optimization criteria includes a user preference.

3. The method of claim 2, wherein the user preference indicates at least one of cost to charge, a time to charge, and a health of batteries.

4. The method of claim 1, wherein the optimization criteria includes weights associated with at least one of cost to charge, a time to charge, and a health of batteries.

5. The method of claim 1, wherein the optimization criteria includes services provided for each routing option.

6. The method of claim 1, wherein the optimization criteria includes weights associated with at least one of confidence and predictability of routing options.

7. The method of claim 1, further comprising: storing user selections associated with the charging route solution; and training a preference model based on the user selections.

8. The method of claim 7, wherein the optimization criteria is based on the trained preference model.

9. The method of claim 1, further comprising generating an interface configured to solicit the data from the user of the vehicle, wherein the data includes at least one of user preferences, weights, and user needs.

10. The method of claim 1, wherein the data received from the one or more charging station includes data associated with a location, a time to charge, a waiting time to charge, and a cost to charge.

11. The method of claim 1, wherein the data received from the vehicle includes data associated with a current charge of the one or more batteries, and a current temperature of the one or more batteries.

12. The method of claim 1, wherein the data received from the one or more vehicle services includes data associated with weather, traffic, topography, and road type.

13. The method of claim 1, wherein the charging route solution includes services available at a chosen charging station, charging duration, charging station location, and the price of the charging.

14. A computer implemented system for controlling a vehicle having one or more batteries, the system comprising:
a charging system module that comprises one or more processors configured by programming instructions encoded in non-transitory computer readable media, the charging system module configured to:
receive data from at least two of a user of the vehicle, the vehicle, one or more charging stations, and one or more vehicle services, and determine, optimization criteria based on the received data;
compute a charging route solution based on the optimization criteria; and
generate interface data for presenting the charging route solution to the user of the vehicle.

15. The computer implemented system of claim 14, wherein the optimization criteria includes a user preference.

16. The computer implemented system of claim 15, wherein the user preference indicates at least one of cost to charge, a time to charge, and a health of batteries.

17. The computer implemented system of claim 14, wherein the optimization criteria includes weights associated with at least one of cost to charge, a time to charge, and a health of batteries.

18. The computer implemented system of claim 14, wherein the optimization criteria includes services provided for each routing option.

19. The computer implemented system of claim 14, wherein the optimization criteria includes weights associated with at least one of confidence and predictability of routing options.

20. The computer implemented system of claim 14, wherein the charging system module is further configured to store user selections associated with the charging route solution, and train a preference model based on the user selections.
